(19) United States
(12) Patent Application Publication
(10) Pub. No.: US 2023/0385778 A1
(43) Pub. Date: Nov. 30, 2023

(54) MEETING THREAD BUILDER

(71) Applicant: MICROSOFT TECHNOLOGY LICENSING, LLC, Redmond, WA (US)

(72) Inventors: Warren David JOHNSON, III, Sammamish, WA (US); Yuchen LI, Redmond, WA (US); Charles Yin-Che LEE, Mercer Island, WA (US)

(21) Appl. No.: 17/826,859

(22) Filed: May 27, 2022

(51) Int. Cl. G06Q 10/10

(52) U.S. Cl. CPC G06Q 10/1095

(57) ABSTRACT

Various embodiments are directed to automatically determining when meetings are related to each other. The relationship between meetings may be stored in a meeting-oriented knowledge graph that can be analyzed to provide meeting analytics. Various technologies can leverage the meeting relationship information to provide improved meeting services to users. For example, meeting suggestions may be presented to a user with suggested meeting parameters (e.g., suggested attendees, suggested location, suggested topic) that are accurate because a relationship between meetings is used to predict the parameters. The information in the meeting-oriented knowledge graph can be used to generate various analytics and visualizations that help users plan or prepare for meetings.

### INTRODUCTION

Computer-implemented technologies can assist users in communicating with each other over communication networks. For example, some teleconferencing technologies use conference bridge components that communicatively connect multiple user devices over a communication network so that users can conduct meetings or otherwise speak with each other in near-real-time. In another example, meeting software applications can include instant messaging, chat functionality, or audio-visual exchange functionality via webcams and microphones for electronic communications.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

As described above, existing technologies fail to understand relationships between meetings. The technology described herein automatically determines when meetings are related to each other. The relationship between meetings may be stored in a meeting-oriented knowledge graph that can be analyzed to provide meeting analytics. Various technologies can leverage the meeting relationship information to provide improved meeting services to users. For example, meeting suggestions may be presented to a user with suggested meeting parameters (e.g., suggested attendees, suggested location, suggested topic) that are accurate because a relationship between meetings is used to predict the parameters.

The information in the meeting-oriented knowledge graph can be used to generate various analytics and visualizations that help users plan or prepare for meetings. These analytics can improve the effectiveness of meetings within an organization by helping determine the purpose of a given meeting in relationship to related meetings that occurred previously. Content (e.g., meeting presentations, agendas, invites, notes, chats, transcripts) from related meeting may also be associated with a common identification, described herein a meeting thread ID. The meeting thread ID can be used to retrieve content from the group of related meetings in response to user request.

The detection of a meeting relationship can occur through natural language processing. Aspects the technology, can detect, through natural language processing, an intent for a new meeting in an utterance made in a first meeting. An intent for a meeting, may be an expressed intention to have another meeting. The intent may be detected using machine learning (e.g., natural language processing) that evaluates utterances and predicts that a speaker wants to have a new meeting. The machine-learning model may analyze a transcript of the meeting. When the meeting intent for a new meeting is detected in the utterance from a first meeting, then the technology described herein may relate the first meeting to the new meeting. The relationship can be recorded as an edge between nodes in a knowledge graph that stores the first meeting and the new meeting as nodes.

In operation, some embodiments first detect a first natural language utterance of one or more attendees associated with the meeting, where the one or more attendees include a first attendee. A meeting intent may be detected in the utterance using natural language processing. In response to identifying a meeting intent, embodiments cause presentation, during or after the meeting of a meeting suggestion. The meeting suggestion is populated with suggested parameters for the meeting for which an intent was expressed. The user may adopt the suggested meeting parameters and authorize output of a meeting invite with the suggested meeting parameters.

### BRIEF DESCRIPTION OF THE DRAWINGS

The present invention is described in detail below with reference to the attached drawing figures, wherein:

FIG. 1 is a block diagram illustrates an example operating environment suitable for implementing some embodiments of the disclosure;

FIG. 2 is a block diagram depicting an example computing architecture suitable for implementing some embodiments of the disclosure;

FIG. 3 is a schematic diagram illustrating different models or layers used to determine a meeting intent, according to some embodiments;

FIG. 4 is a schematic diagram illustrating how a neural network makes particular training and deployment predictions given specific inputs, according to some embodiments;

FIG. 5 is a schematic diagram of an example meeting-oriented knowledge graph, according to some embodiments;

FIG. 6 is an example screenshot illustrating a meeting invite generated from a natural language utterance, according to some embodiments;

FIG. 7 is an example screenshot illustrating presentation of a meeting tree, according to some embodiments;

FIG. 8 is a flow diagram of an example process for generating a meeting-oriented knowledge graph, according to some embodiments;

FIG. 9 is a flow diagram of an example process for generating a meeting-oriented knowledge graph, according to some embodiments;

FIG. 10 is a flow diagram of an example process for generating a meeting-oriented knowledge graph from a meeting transcript, according to some embodiments; and

FIG. 11 is a block diagram of an example computing device suitable for use in implementing some embodiments described herein.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a stand-alone application, a service or hosted service (stand-alone or in combination with another hosted service), or a plug-in to another product, to name a few.

Existing meeting software does not track the relationship between meetings or help the user understand the purpose of a meeting with relationship to a previous meeting. Further, the meeting software fails to help a user prepare for a meeting by putting a current meeting (and meeting content) in the context of a related group of one or more meetings. As described above, existing technologies fail to understand relationships between meetings. The technology described herein automatically determines when meetings are related to each other. The relationship between meetings may be stored in a meeting-oriented knowledge graph that can be analyzed to provide meeting analytics. Various technologies can leverage the meeting relationship information to provide improved meeting services to users. For example, meeting suggestions may be presented to a user with suggested meeting parameters (e.g., suggested attendees, suggested location, suggested topic) that are accurate because a relationship between meetings is used to predict the parameters.

The information in the meeting-oriented knowledge graph can be used to generate various analytics and visualizations that help users plan or prepare for meetings. These analytics can improve the effectiveness of meetings within an organization by helping determine the purpose of a given meeting in relationship to related meetings that occurred previously. Information about a group of meetings can be presented at different levels of detail in single document or interface. The information could be as high-level as a meeting subject and date for each related meeting. Views that are more detailed can provide meeting minutes and other substantive content for each related meeting, such as decisions taken in a meeting.

Content (e.g., meeting presentations, agendas, invites, notes, chats, transcripts) from related meeting may also be associated with a common identification, described herein as a meeting thread ID. The association could be direct, such as by associating the thread ID as metadata to a content. The association could be indirect using an index, or other data store, that associates a content ID with a meeting thread ID. The meeting thread ID can be used to retrieve content from the group of related meetings in response to a query. Aspects may provide an interface command that allows the user to request presentation of content related to a group of related meetings. Previously, documents and other content may appear unrelated or have a weak relationship. The meeting thread ID can be a signal that relates otherwise weakly related or unrelated content.

The meeting thread ID can act as an input signal to machine-learning process that communicates a relationship exists between content that would not otherwise have a predictable relationship. This input signal can improve the accuracy of search results and associated relevance ranking. For example, a user with a known interest in first document may be determined likely interested in a second document because the first and second documents are associated with related meetings.

The meeting thread ID can be used to improve semantic understanding of language models. At a high level, various signals may be used to train word-embedding models. Conceptually, a goal of the word-embedding model may be to represent words and concepts with similar meaning with similar values that are “nearby.” Including the meeting thread ID can surface otherwise unknown relationships between concepts and topics being discussed in related meetings.

The meeting relationships may be visually depicted in a meeting tree that represents meetings in a user interface. The arrangement of meetings can be used to depict relative characteristics of the meeting such as a meeting date. For example, a meeting occurring earlier may be displayed at the top of the display with meetings occurring subsequently shown at the bottom of the display.

The detection of a meeting relationship can occur through natural language processing. Aspects of the technology, can detect, through natural language processing, an intent for a new meeting in an utterance made in a first meeting. In one aspect, an intent for a meeting, is an intention to have another meeting. The intent may be detected using machine learning that evaluates utterances and predicts that a speaker wants to have a new meeting. The machine-learning model may analyze a transcript of the meeting. In response, the technology can provide a meeting suggestion prepared in response to the intent. If the meeting suggestion is adopted and a meeting scheduled based on the suggestion, then the first meeting in which the utterance occurred and the follow-up meeting may be identified as related.

In one aspect, a meeting relationship is formed when a second meeting is described in content related to a first meeting. The content for the first meeting may be a transcript of utterances made in the first meeting. The content could also be meeting notes (e.g., minutes) for the first meeting. The description may be an expressed intent to conduct the second meeting. The second meeting may already be scheduled or yet to be scheduled. When the meeting intent for a new meeting is detected in the utterance from a first meeting, then the technology described herein may relate the first meeting to the new meeting. The relationship can be recorded as an edge between nodes in a meeting-oriented knowledge graph that stores meetings as nodes.

In one aspect, a meeting intent is an intention to accomplish a task in a yet to occur meeting. The meeting may yet to be scheduled or may be scheduled, but yet to occur at the time of the utterance in which the intent was detected. The timing of the actual analysis of the utterance to detect the intention is independent of when the related meetings occur. Thus, a meeting intention could be detected two years or more after both meetings occurred. The detected intent could still be used to retroactively relate the meetings.

Various embodiments of the present disclosure provide one or more technical solutions to these technical problems, as well as other problems, as described herein. For instance, particular embodiments are directed to causing presentation, to one or more user devices associated with one or more meeting attendees, of one or more meeting suggestions based at least in part on one or more natural language utterances made during a meeting. In other words, particular embodiments automatically suggest a follow up meeting during or after a meeting based at least in part on real-time natural language utterances in the meeting.

In operation, some embodiments first detect a first natural language utterance of one or more attendees associated with the meeting, where the one or more attendees include a first attendee. For example, a microphone may receive near real-time audio data, and an associated user device may then transmit, over a computer network, the near real-time audio data to a speech-to-text service so that the speech-to-text service can encode the audio data into text data and then perform natural language processing (NLP) to detect that a user made an utterance.

Based at least in part on the identifying a meeting intent, particular embodiments cause presentation, during or after the meeting and to the first user device associated with the first attendee, of at least a meeting suggestion. The meeting suggestion is populated with suggested parameters for the meeting. Accordingly, particular embodiments will automatically cause presentation (for example, without a manual user request) of the meeting suggestion.

Particular embodiments improve existing technologies because of the way they score or rank each meeting parameter in the meeting suggestion based on understanding the first meeting is related to the second meeting being suggested.

Particular embodiments improve user interfaces and human-computer interaction by automatically causing presentation of relationships between meetings and analytics derived from these relationships.

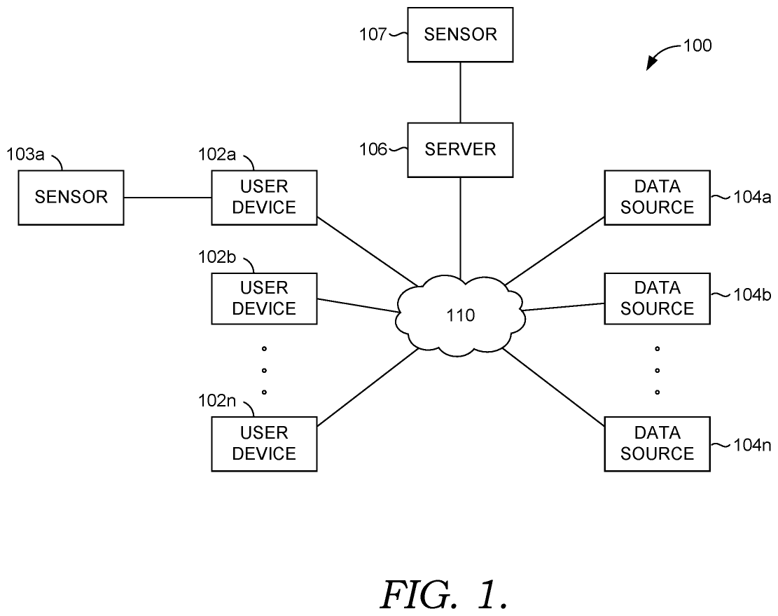

Turning now to FIG. 1, a block diagram is provided showing an example operating environment 100 in which some embodiments of the present disclosure may be employed. It should be understood that this and other arrangements described herein are set forth only as examples. Other arrangements and elements (for example, machines, interfaces, functions, orders, and groupings of functions) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by an entity may be carried out by hardware, firmware, and/or software. For instance, some functions may be carried out by a processor executing instructions stored in memory.

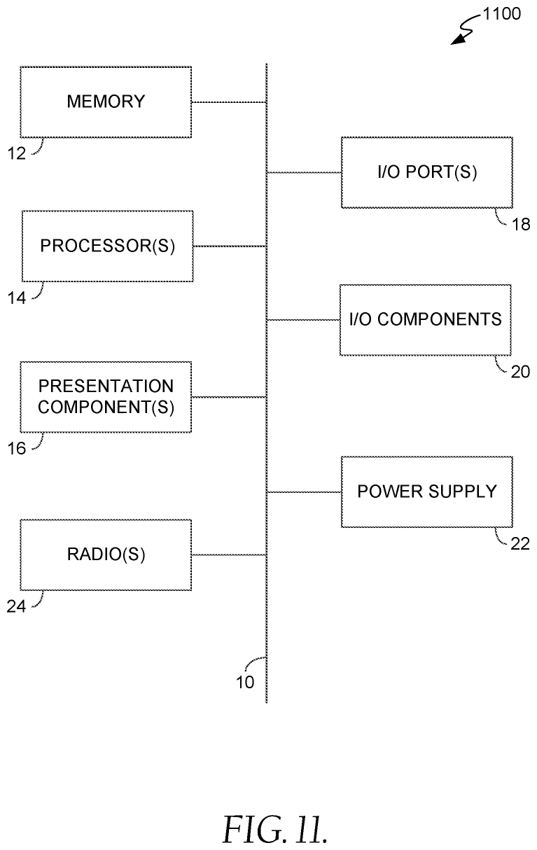

Among other components not shown, example operating environment 100 includes a number of user devices, such as user devices 102a and 102b through 102n; a number of data sources (for example, databases or other data stores), such as data sources 104a and 104b through 104n; server 106; sensors 103a and 107; and network(s) 110. It should be understood that environment 100 shown in FIG. 1 is an example of one suitable operating environment. Each of the components shown in FIG. 1 may be implemented via any type of computing device, such as computing device 1100 as described in connection to FIG. 11, for example. These components may communicate with each other via network(s) 110, which may include, without limitation, a local area network (LAN) and/or a wide area networks (WAN). In some implementations, network(s) 110 comprises the Internet and/or a cellular network, amongst any of a variety of possible public and/or private networks. As an example, user devices 102a and 102b through 102n may conduct a video conference using network(s) 110.

It should be understood that any number of user devices, servers, and data sources might be employed within operating environment 100 within the scope of the present disclosure. Each may comprise a single device or multiple devices cooperating in a distributed environment. For instance, server 106 may be provided via multiple devices arranged in a distributed environment that collectively provide the functionality described herein. Additionally, other components not shown may also be included within the distributed environment.

User devices 102a and 102b through 102n can be client devices on the client-side of operating environment 100, while server 106 can be on the server-side of operating environment 100. Server 106 can comprise server-side software designed to work in conjunction with client-side software on user devices 102a and 102b through 102n to implement any combination of the features and functionalities discussed in the present disclosure. This division of operating environment 100 is provided to illustrate one example of a suitable environment, and there is no requirement for each implementation that any combination of server 106 and user devices 102a and 102b through 102n remain as separate entities. In some embodiments, the one or more servers 106 represent one or more nodes in a cloud computing environment. Consistent with various embodiments, a cloud computing environment includes a network-based, distributed data processing system that provides one or more cloud computing services. Further, a cloud-computing environment can include many computers, hundreds or thousands of them or more, disposed within one or more data centers and configured to share resources over the one or more network(s) 110.

In some embodiments, a user device 102a or server 106 alternatively or additionally comprises one or more web servers and/or application servers to facilitate delivering web or online content to browsers installed on a user device 102b. Often the content may include static content and dynamic content. When a client application, such as a web browser, requests a website or web application via a URL or search term, the browser typically contacts a web server to request static content or the basic components of a website or web application (for example, HTML pages, image files, video files, and the like). Application servers typically deliver any dynamic portions of web applications or business logic portions of web applications. Business logic can be described as functionality that manages communication between a user device and a data store (for example, a database or knowledge graph). Such functionality can include business rules or workflows (for example, code that indicates conditional if/then statements, while statements, and the like to denote an order of processes).

User devices 102a and 102b through 102n may comprise any type of computing device capable of use by a user. For example, in one embodiment, user devices 102a through 102n may be the type of computing device described in relation to FIG. 11 herein. By way of example and not limitation, a user device may be embodied as a personal computer (PC), a laptop computer, a mobile phone or mobile device, a smartphone, a tablet computer, a smart watch, a wearable computer, a personal digital assistant (PDA), a music player or an MP3 player, a global positioning system (GPS) or device, a video player, a handheld communications device, a gaming device or system, an entertainment system, a vehicle computer system, an embedded system controller, a camera, a remote control, a bar code scanner, a computerized measuring device, an appliance, a consumer electronic device, a workstation, or any combination of these delineated devices, or any other suitable computer device.

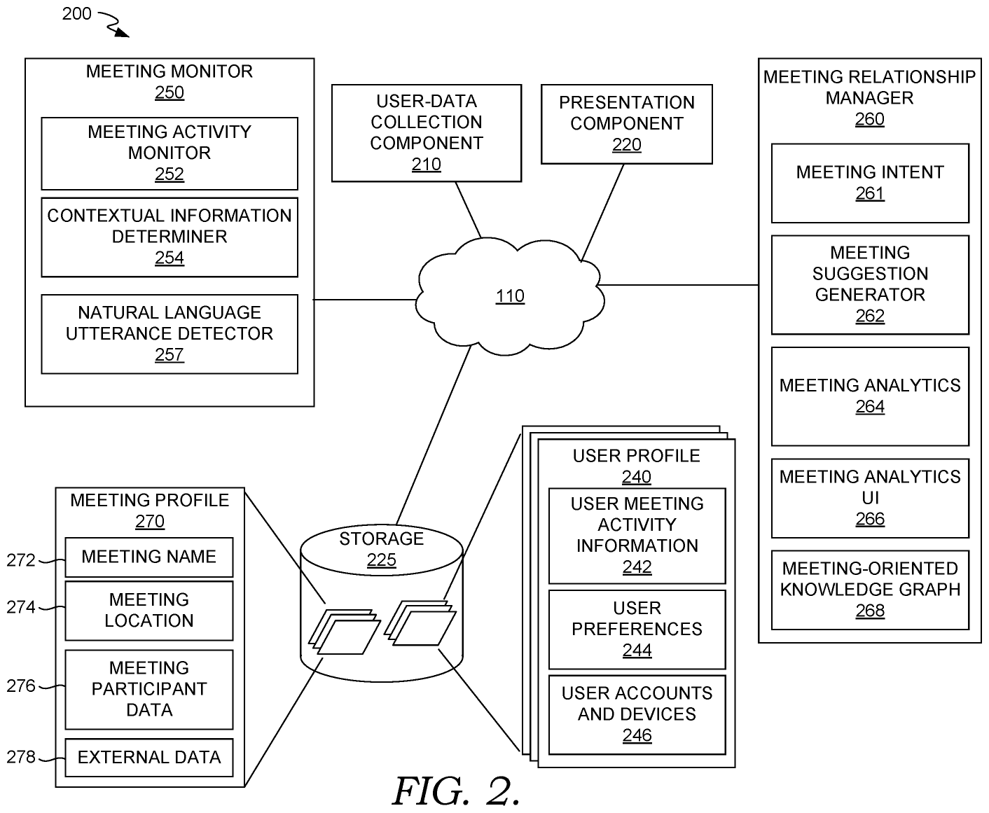

Data sources 104a and 104b through 104n may comprise data sources and/or data systems, which are configured to make data available to any of the various constituents of operating environment 100 or system 200 described in connection to FIG. 2. Examples of data source(s) 104a through 104n may be one or more of a database, a file, data structure, corpus, or other data store. Data sources 104a and 104b through 104n may be discrete from user devices 102a and 102b through 102n and server 106 or may be incorporated and/or integrated into at least one of those components. In one embodiment, data sources 104a through 104n comprise sensors (such as sensors 103a and 107), which may be integrated into or associated with the user device(s) 102a, 102b, or 102n or server 106. The data sources 104a and 104b through 104n may store meeting content, such as files shared during the meeting, generated in response to a meeting (e.g., meeting notes or minutes), and/or shared in preparation for a meeting. The data sources 104a and 104b through 104n may store calendar schedules.

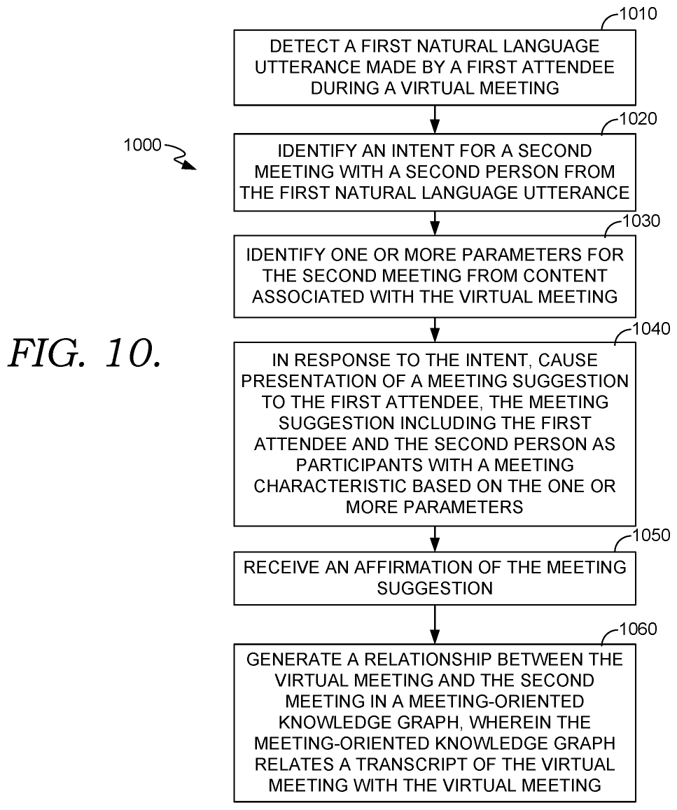

Operating environment 100 can be utilized to implement one or more of the components of the system 200, described in FIG. 2, including components for scoring meeting intent, ascertaining relationships between meetings, and causing presentation of meeting trees during or before a meeting, as described herein. Operating environment 100 also can be utilized for implementing aspects of processes 1000, 1100, and/or 1200 described in conjunction with FIGS. 10, 11, and 12, and any other functionality as described in connection with FIGS. 2-11.

Referring now to FIG. 2, with FIG. 1, a block diagram is provided showing aspects of an example computing system architecture suitable for implementing some embodiments of the disclosure and designated generally as system 200. The system 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Example system 200 includes network 110, which is described in connection to FIG. 1, and which communicatively couples components of system 200 including meeting monitor 250, user-data collection component 210, presentation component 220, meeting-relationship manager 260, and storage 225. These components may be embodied as a set of compiled computer instructions or functions, program modules, computer software services, or an arrangement of processes carried out on one or more computer systems, such as computing device 1100 described in connection to FIG. 11, for example.

In one embodiment, the functions performed by components of system 200 are associated with one or more personal assistant applications, services, or routines. In particular, such applications, services, or routines may operate on one or more user devices (such as user device 102a), servers (such as server 106), may be distributed across one or more user devices and servers, or be implemented in the cloud. Moreover, in some embodiments, these components of system 200 may be distributed across a network, including one or more servers (such as server 106) and client devices (such as user device 102a), in the cloud, or may reside on a user device, such as user device 102a. Moreover, these components, functions performed by these components, or services carried out by these components may be implemented at appropriate abstraction layer(s) such as the operating system layer, application layer, hardware layer of the computing system(s). Alternatively, or in addition, the functionality of these components and/or the embodiments described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs). Additionally, although functionality is described herein with regards to specific components shown in example system 200, it is contemplated that in some embodiments functionality of these components can be shared or distributed across other components.

Continuing with FIG. 2, user-data collection component 210 is generally responsible for accessing or receiving (and in some cases also identifying) user data from one or more data sources, such as data sources 104a and 104b through 104n of FIG. 1. In some embodiments, user-data collection component 210 may be employed to facilitate the accumulation of user data of a particular user (or in some cases, a plurality of users including crowdsourced data) for the meeting monitor 250 or the meeting-relationship manager 260. In some embodiments, a “user” as designated herein may be replaced with the term “attendee” of a meeting. The data may be received (or accessed), and optionally accumulated, reformatted, and/or combined, by user-data collection component 210 and stored in one or more data stores such as storage 225, where it may be available to other components of system 200. The data may be represented in the meeting-oriented knowledge graph 268. For example, the user data may be stored in or associated with a user profile 240, as described herein. In some embodiments, any personally identifying data (i.e., user data that specifically identifies particular users) is either not uploaded or otherwise provided from the one or more data sources with user data, is not permanently stored, and/or is not made available to the components or subcomponents of system 200. In some embodiments, a user may opt into or out of services provided by the technologies described herein and/or select which user data and/or which sources of user data are to be utilized by these technologies.

User data may be received from a variety of sources where the data may be available in a variety of formats. The user data may be related to meetings. In aspects, the user data may be collected by scheduling applications, calendar applications, email applications, and or virtual meeting (e.g., video conference) applications. In some embodiments, user data received via user-data collection component 210 may be determined via one or more sensors, which may be on or associated with one or more user devices (such as user device 102a), servers (such as server 106), and/or other computing devices. A sensor may include a function, routine, component, or combination thereof for sensing, detecting, or otherwise obtaining information such as user data from a data source 104a, and may be embodied as hardware, software, or both. By way of example and not limitation, user data may include data that is sensed or determined from one or more sensors (referred to herein as sensor data), such as location information of mobile device(s), properties or characteristics of the user device(s) (such as device state, charging data, date/time, or other information derived from a user device such as a mobile device), user-activity information (for example: app usage; online activity; searches; voice data such as automatic speech recognition; activity logs; communications data including calls, texts, instant messages, and emails; website posts; other user data associated with communication events) including, in some embodiments, user activity that occurs over more than one user device, user history, session logs, application data, contacts data, calendar and schedule data, notification data, social-network data, news (including popular or trending items on search engines or social networks), online gaming data, ecommerce activity (including data from online accounts such as Microsoft®, Amazon.com®, Google®, eBay®, PayPal®, video-streaming services, gaming services, or Xbox Live®), user-account(s) data (which may include data from user preferences or settings associated with a personal assistant application or service), home-sensor data, appliance data, GPS data, vehicle signal data, traffic data, weather data (including forecasts), wearable device data, other user device data (which may include device settings, profiles, network-related information (such as network name or ID, domain information, workgroup information, connection data, Wi-Fi network data, or configuration data, data regarding the model number, firmware, or equipment, device pairings, such as where a user has a mobile phone paired with a Bluetooth headset, for example, or other network-related information)), gyroscope data, accelerometer data, payment or credit card usage data (which may include information from a user's PayPal account), purchase history data (such as information from a user's Xbox Live, Amazon.com, or eBay account), other sensor data that may be sensed or otherwise detected by a sensor (or other detector) component(s) including data derived from a sensor component associated with the user (including location, motion, orientation, position, user-access, user-activity, network-access, user-device-charging, or other data that is capable of being provided by one or more sensor components), data derived based on other data (for example, location data that can be derived from Wi-Fi, Cellular network, or IP address data), and nearly any other source of data that may be sensed or determined as described herein.

User data can be received by user-data collection component 210 from one or more sensors and/or computing devices associated with a user. While it is contemplated that the user data may be processed, for example by the sensors or other components not shown, for interpretability by user-data collection component 210, embodiments described herein do not limit the user data to processed data and may include raw data. In some embodiments, user-data collection component 210 or other components of system 200 may determine interpretive data from received user data. Interpretive data corresponds to data utilized by the components of system 200 to interpret user data. For example, interpretive data can be used to provide context to user data, which can support determinations or inferences made by the components or subcomponents of system 200, such as venue information from a location, a text corpus from user speech (i.e., speech-to-text), or aspects of spoken language understanding. Moreover, it is contemplated that for some embodiments, the components or subcomponents of system 200 may use user data and/or user data in combination with interpretive data for carrying out the objectives of the subcomponents described herein.

In some respects, user data may be provided in user-data streams or signals. A “user signal” can be a feed or stream of user data from a corresponding data source. For instance, a user signal could be from a smartphone, a home-sensor device, a smart speaker, a GPS device (for example, location coordinates), a vehicle-sensor device, a wearable device, a user device, a gyroscope sensor, an accelerometer sensor, a calendar service, an email account, a credit card account, or other data source. In some embodiments, user-data collection component 210 receives or accesses user-related data continuously, periodically, as it becomes available, or as needed. Location data could be used to determine whether a user is present at an in-person meeting on the user's calendar by comparing a scheduled location of the meeting with a location reading at the time.

Continuing with FIG. 2, example system 200 includes a meeting monitor 250. The meetings being monitored may be virtual meetings that occur via teleconference, video conference, virtual reality, or some other technology enabled platform. The meetings may be in-person meetings where all meeting attendees are geographically collocated. The meetings may be hybrid with some attendees co-located, while others attend virtually using technology. The meeting monitor 250 includes meeting activity monitor 252 contextual information determiner 254, and natural language utterance detector 257. The Meeting monitor 250 is generally responsible for determining and/or detecting meeting features from online meetings and/or in-person meetings and making the meeting features available to the other components of the system 200. For example, such monitored activity can be meeting location (for example, as determined by geo-location of user devices), topic of the meeting, invitees of the meeting, attendees of the meeting, whether the meeting is recurring, related deadlines, projects, and the like. In some aspects, meeting monitor 250 determines and provides a set of meeting features (such as described below), for a particular meeting, and for each user associated with the meeting. In some aspects, the meeting may be a past (or historic) meeting or a current meeting. Further, it should be appreciated that the meeting monitor 250 may be responsible for monitoring any number of meetings, for example, each online meeting associated with the system 200. Accordingly, the features corresponding to the online meetings determined by meeting monitor 250 may be used to analyze a plurality of meetings and determine corresponding patterns. Meeting patterns may be used to identify relationships between meetings. These relationships can be documented in meeting-oriented knowledge graph 268.

In some embodiments, the input into the meeting monitor 250 is sensor data and/or user device data of one or more users (i.e., attendees) at a meeting and/or contextual information from a meeting invite and/or email or other device activity of users at the meeting. In some embodiments, this includes user data collected by the user-data collection component 210 (which can be accessible via the user profile 240).

The meeting activity monitor 252 is generally responsible for monitoring meeting events (such as user activity) via one or more sensors, (such as microphones, video), devices, chats, presented content, and the like. In some embodiments, the meeting activity monitor 252 outputs transcripts or activity that happens during a meeting. For example, activity or content may be timestamped or otherwise correlated with meeting transcripts. In an illustrative example, the meeting activity monitor 252 may indicate a clock time at which the meeting begins and ends. In some embodiments, the meeting activity monitor 252 monitors user activity information from multiple user devices associated with the user and/or from cloud-based services associated with the user (such as email, calendars, social media, or similar information sources), and which may include contextual information associated with transcripts or content of an event. For example, an email may detail conversations between two participants that provide context to a meeting transcript by describing details of the meeting, such as purpose of the meeting. The meeting activity monitor 252 may determine current or near-real-time user activity information and may also determine historical user activity information, in some embodiments, which may be determined based on gathering observations of user activity over time and/or accessing user logs of past activity (such as browsing history, for example). Further, in some embodiments, the meeting activity monitor may determine user activity (which may include historical activity) from other similar users (i.e., crowdsourcing).

In embodiments using contextual information (such as via the contextual information determiner 254) related to user devices, a user device may be identified by the meeting activity monitor 252 by detecting and analyzing characteristics of the user device, such as device hardware, software such as OS, network-related characteristics, user accounts accessed via the device, and similar characteristics. For example, as described previously, information about a user device may be determined using functionality of many operating systems to provide information about the hardware, OS version, network connection information, installed application, or the like. In some embodiments, a device name or identification (device ID) may be determined for each device associated with a user. This information about the identified user devices associated with a user may be stored in a user profile associated with the user, such as in user account(s) and device(s) 244 of user profile 240. In an embodiment, the user devices may be polled, interrogated, or otherwise analyzed to determine contextual information about the devices. This information may be used for determining a label or identification of the device (such as a device ID) so that user activity on one user device may be recognized and distinguished from user activity on another user device. Further, as described previously, in some embodiments, users may declare or register a user device, such as by logging into an account via the device, installing an application on the device, connecting to an online service that interrogates the device, or otherwise providing information about the device to an application or service. In some embodiments devices that sign into an account associated with the user, such as a Microsoft® account or Net Passport, email account, social network, or the like, are identified and determined to be associated with the user.

In some embodiments, meeting activity monitor 252 monitors user data associated with the user devices and other related information on a user device, across multiple computing devices (for example, associated with all participants in a meeting), or in the cloud. Information about the user's devices may be determined from the user data made available via user-data collection component 210 and may be provided to the meeting manager 260, among other components of system 200, to make predictions of whether character sequences or other content is an action item. In some implementations of meeting activity monitor 252, a user device may be identified by detecting and analyzing characteristics of the user device, such as device hardware, software such as OS, network-related characteristics, user accounts accessed via the device, and similar characteristics, as described above. For example, information about a user device may be determined using functionality of many operating systems to provide information about the hardware, OS version, network connection information, installed application, or the like. Similarly, some embodiments of meeting activity monitor 252, or its subcomponents, may determine a device name or identification (device ID) for each device associated with a user.

The contextual information extractor/determiner 254 is generally responsible for determining contextual information (also referred to herein as “context”) associated with a meeting and/or one or more meeting attendees. This information may be metadata or other data that is not the actual meeting content itself, but describes related information. For example, context may include who is present or invited to a meeting, the topic of the meeting, whether the meeting is recurring or not recurring, the location of the meeting, the date of the meeting, the relationship between other projects or other meetings, information about invited or actual attendees of the meeting (such as company role, whether participants are from the same company, and the like). In some embodiments, the contextual information extractor/determiner 254 determines some or all of the information by determining information (such as doing a computer read of) within the user profile 240 or meeting profile 270, as described in more detail below.

The natural language utterance detector 257 is generally responsible for detecting one or more natural language utterances from one or more attendees of a meeting or other event. For example, in some embodiments, the natural language utterance detector 257 detects natural language via a speech-to-text service. For example, an activated microphone at a user device can pick up or capture near-real time utterances of a user and the user device may transmit, over the network(s) 110, the speech data to a speech-to-text service that encodes or converts the audio speech to text data using natural language processing. In another example, the natural language utterance detector 257 can detect natural language utterances (such as chat messages) via natural language processing (NLP) only via, for example, parsing each word, tokenizing each word, tagging each word with a Part-of-Speech (POS) tag, and/or the like to determine the syntactic or semantic context. In these embodiments, the input may not be audio data, but may be written natural language utterances, such as chat messages. In some embodiments, NLP includes using NLP models, such as Bidirectional Encoder Representations from Transformers (BERT) (for example, via Next Sentence Prediction (NSP) or Mask Language Modeling (MLM)) in order to convert the audio data to text data in a document.

In some embodiments, the natural language utterance detector 257 detects natural language utterances using speech recognition or voice recognition functionality via one or more models. For example, the natural language utterance detector 257 can use one or more models, such as a Hidden Markov Model (HMM), Gaussian Mixture Model (GMM), Long Short Term Memory (LSTM), BERT, and/or or other sequencing or natural language processing model to detect natural language utterances and make attributions to given attendees. For example, an HMM can learn one or more voice patterns of specific attendees. For instance, HMM can determine a pattern in the amplitude, frequency, and/or wavelength values for particular tones of one or more voice utterances (such as phenomes) that a user has made. In some embodiments, the inputs used by these one or more models include voice input samples, as collected by the user-data collection component 210. For example, the one or more models can receive historical telephone calls, smart speaker utterances, video conference auditory data, and/or any sample of a particular user's voice. In various instances, these voice input samples are pre-labeled or classified as the particular user's voice before training in supervised machine learning contexts. In this way, certain weights associated with certain features of the user's voice can be learned and associated with a user, as described in more detail herein. In some embodiments, these voice input samples are not labeled and are clustered or otherwise predicted in non-supervised contexts. Utterances may be attributed to attendees based on the device that transmitted the utterance. In a virtual meeting, the virtual meeting application may associate each utterance with a device that input to the audio signal to the meeting.

The user profile 240 generally refers to data about a specific user or attendee, such as learned information an attendee, personal preferences of attendees, and the like. The user profile 240 includes the user meeting activity information 242, user preferences 244, and user accounts and devices 246. User meeting activity information 242 may include indications of when attendees or speakers tend to intend to set up additional meetings that were identified via patterns in prior meetings, how attendees identify attendees (via a certain name), and who they are talking to when they express a meeting intent.

The user profile 240 can include user preferences 244, which generally include user settings or preferences associated with meeting monitor 250. By way of example and not limitation, such settings may include user preferences about specific meeting (and related information) that the user desires to be explicitly monitored or not monitored or categories of events to be monitored or not monitored, crowdsourcing preferences, such as whether to use crowdsourced information, or whether the user's event information may be shared as crowdsourcing data; preferences about which events consumers may consume the user's event pattern information; and thresholds, and/or notification preferences, as described herein. In some embodiments, user preferences 244 may be or include, for example: a particular user-selected communication channel (for example, SMS text, instant chat, email, video, and the like) for content items to be transmitted through.

User accounts and devices 246 generally refer to device IDs (or other attributes, such as CPU, memory, or type) that belong to a user, as well as account information, such as name, business unit, team members, role, and the like. In some embodiment, role corresponds to meeting attendee company title or other ID. For example, participant role can be or include one or more job titles of an attendee, such as software engineer, marketing director, CEO, CIO, managing software engineer, deputy general counsel, vice president of internal affairs, and the like. In some embodiments, the user profile 240 includes participant roles of each participant in a meeting. The participant or attendee may be represented as a node in the meeting-oriented knowledge graph 268. Additional user data that is not in the node may be accessed via a reference to the meeting profile 270.

Meeting profile 270 corresponds meeting data and associated metadata (such as collected by the user-data collection component 210). The meeting profile 270 includes meeting name 272, meeting location 274, meeting participant data 276, and external data 278. Meeting name 272 corresponds to the title or topic (or sub-topic) of an event or identifier that identifies a meeting. This topic may be extracted from a subject line of a meeting invite or from a meeting agenda. Meeting relationships can be determined based at least in part on the meeting name 272, meeting location 274, participant data 276, and external data 278. In one aspect, a similarity measure is used to determine whether two meetings are related. Meetings with above a threshold similarity may be related. In other cases, rules may be used to determine whether a meeting is related. The results can include an overlap in attendees, closeness in time (e.g., within a month), and a common topic.

Meeting location 274 corresponds to the geographical location or type of meeting. For example, Meeting location 274 can indicate the physical address of the meeting or building/room identifier of the meeting location. The meeting location 274 may indicate that the meeting is a virtual or online meeting or in-person meeting. The event location 274 can also be a signal for determining whether meetings are related. This is because certain meeting locations are associated with certain topics and or groups working together. For example, if it is determined that the meeting is at building B, which is a building where engineering testing occurs, other meetings in building B are more likely to be related to each other than meetings in building C, where lawyers work.

Meeting participant data 276 indicates the names or other identifiers of attendees at a particular meeting. In some embodiments, the meeting participant data 276 includes the relationship between attendees at a meeting. For example, the meeting participant data 276 can include a graphical view or hierarchical tree structure that indicates the highest managerial position at the top or root node, with an intermediate-level manager at the branches just under the managerial position, and a senior worker at the leaf level under the intermediate-level manager. In some embodiments, the names or other identifiers of attendees at a meeting are determined automatically or in near-real-time as users speak (for example, based on voice recognition algorithms) or can be determined based on manual input of the attendees, invitees, or administrators of a meeting. In some embodiments, in response to determining the meeting participant data 276, the system 200 then retrieves or generates a user profile 240 for each participant of a meeting.

External data 278 corresponds to any other suitable information that can be used to determine a meeting intent or meeting parameters. In some embodiments, external data 278 includes any non-personalized data that can still be used to make predictions. For example, external data 278 can include learned information of human habits over several meetings even though the current participant pool for a current event is different from the participant pool that attended the historical meetings. This information can be obtained via remote sources such as blogs, social media platforms, or other data sources unrelated to a current meeting. In an illustrative example, it can be determined over time that for a particular organization or business unit, meetings are typically scheduled before 3:00 PM. Thus, an utterance in a meeting about getting together for dinner, might not express an intention to schedule a related meeting. Instead, the utterance might describe an unrelated social plan.

Continuing with FIG. 2, the system 200 includes the meeting manager 260. The meeting manager 260 is generally identifying meeting relationships, storing the relationships, and leveraging the relationship information to generate analytics that help a user understand the purpose of a given meeting. The meeting manager 260 includes the meeting intent detector 261, the meeting suggestion generator 262, the meeting analytics component 264, the meeting analytics UI 266, and the meeting-oriented knowledge graph 268. In some embodiments, the functionality engaged in by the meeting manager 260 is based on information contained in the user profile 240, the meeting profile 270, information determined via the meeting monitor 250, and/or data collected via the user-data collection component 210, as described in more detail below.

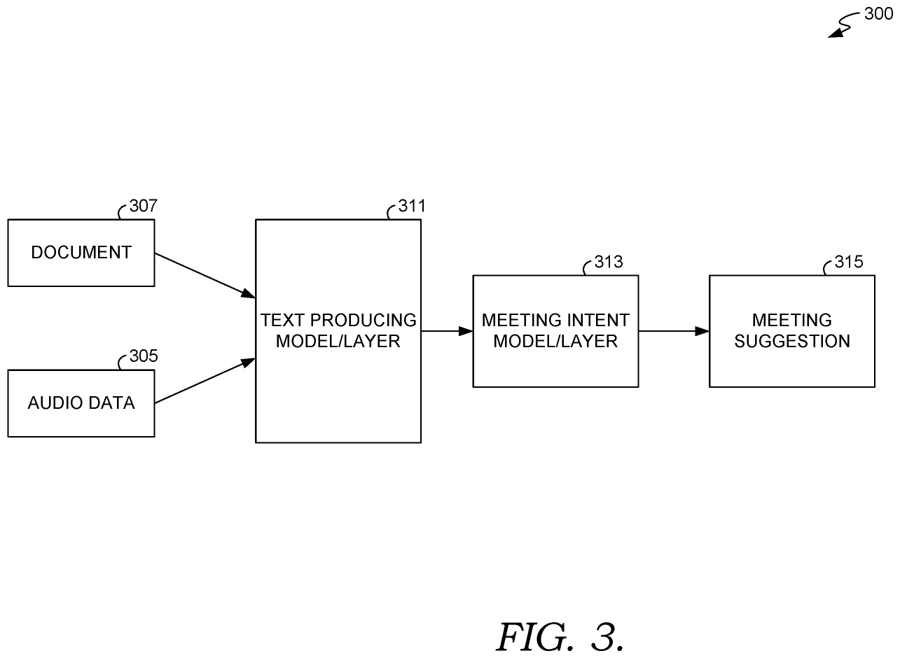

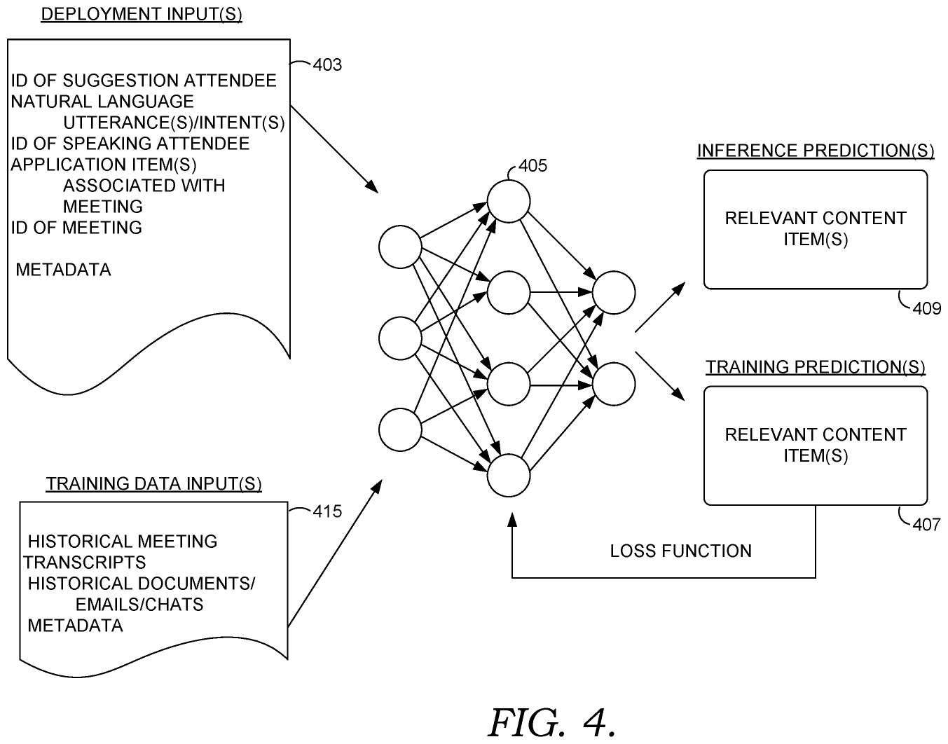

The meeting intent detector 261 receives a natural language utterance associated with a first meeting and detects a meeting intent for a second meeting. The natural language utterance may be in meeting content from the first meeting. The meeting content may be a transcript of utterances made in the first meeting. The intent may be detected using a machine-learning model that is trained to detect meeting intents. A possible machine-learning model used for detecting meeting intent is described in FIGS. 3 and 4. The output of the meeting intent detector 261 is an indication that a meeting intent is present in an utterance. The strength of the prediction (e.g., a confidence factor) may also be output. The portion of the transcript, speaker of the utterance, and other information related to the first meeting may be output to other components, such as the meeting suggestion generator 262. When the meeting intent for a new meeting is detected in the utterance from a first meeting, then the technology described herein may relate the first meeting to the new meeting. The relationship can be recorded as an edge between nodes in a knowledge graph that stores meetings as nodes.

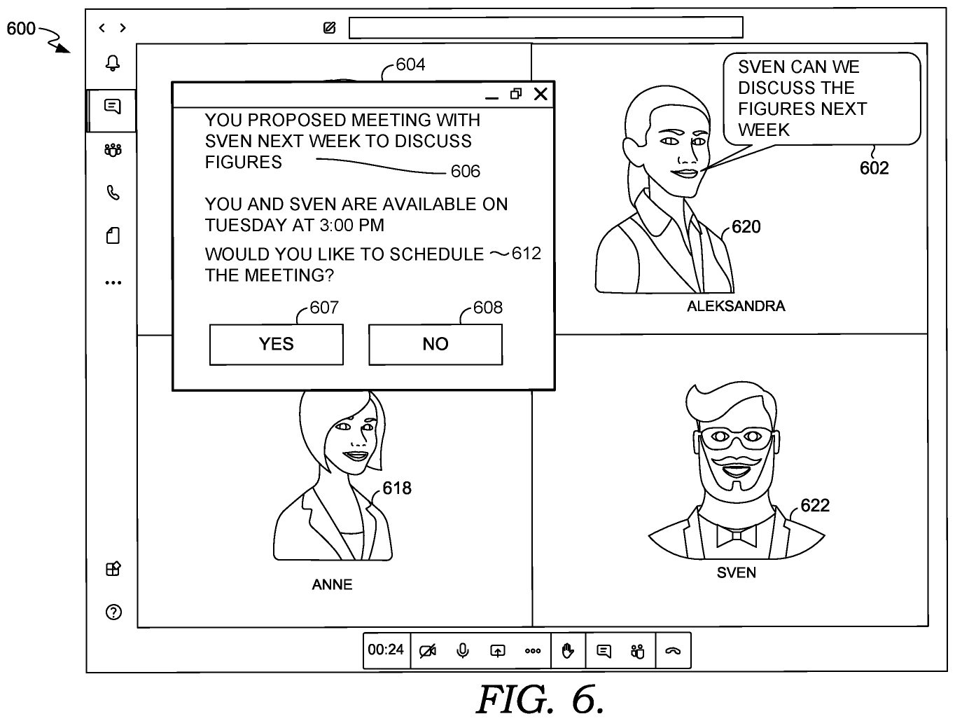

The meeting suggestion generator 262 generates a meeting suggestion in response to meeting intent. The meeting suggestion attempts to predict meeting parameters that are consistent with the meeting intent. The meeting suggestion may be based on entity extraction performed on the utterances made in the first meeting. A machine-learned model may identify entities that are possibly associated with a future meeting, such as a time, location, topics, and attendees. The characteristics of the first meeting may also be used to select meeting parameters. For example, the suggested meeting may use the same virtual meeting platform, same location (if in-person) and include the same attendees. The suggested time may be determined by evaluating availability of proposed attendees through their electronic calendars within a time frame suggested by an utterance (e.g., next week, next month). An example, meeting suggestion interface is described in FIG. 6. The machine learned model used to generate the meeting parameters is descried with reference to FIGS. 3 and 4.

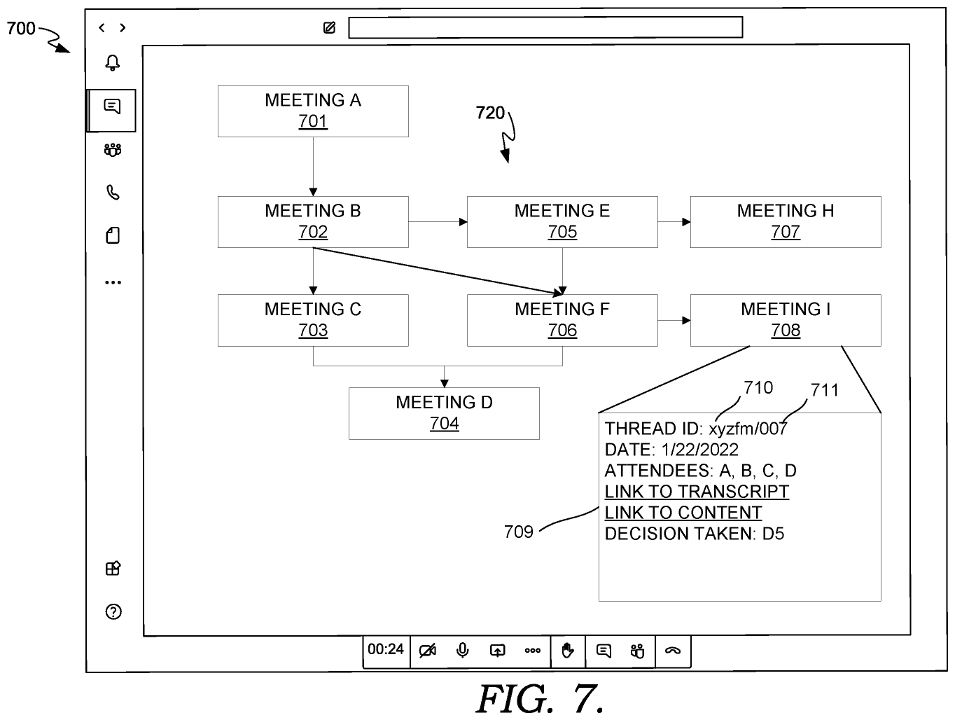

The meeting analytics component 264 leverages meeting relationship data to provide meaningful information to users through the meeting analytics UI 266. The meeting tree of FIG. 7 is one example of a meeting analytic. Other analytics can attempt to measure the effectiveness of individual meetings or a group of meetings.

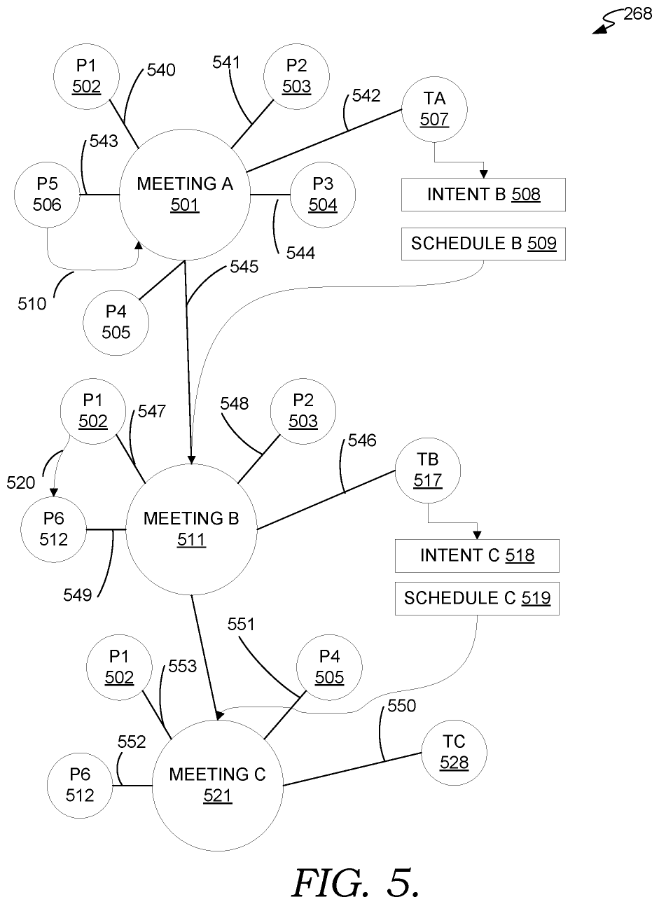

The meeting-oriented knowledge graph 268 stores relationships between meetings along with other information. The meeting-oriented knowledge graph is described in more detail with reference to FIG. 5.

Example system 200 also includes a presentation component 220 that is generally responsible for presenting content and related information to a user, such a meeting invite, as described in FIG. 6, or meeting tree, as described in FIG. 7. Presentation component 220 may comprise one or more applications or services on a user device, across multiple user devices, or in the cloud. For example, in one embodiment, presentation component 220 manages the presentation of content to a user across multiple user devices associated with that user. Based on content logic, device features, associated logical hubs, inferred logical location of the user, and/or other user data, presentation component 220 may determine on which user device(s) content is presented, as well as the context of the presentation, such as how (or in what format and how much content, which can be dependent on the user device or context) it is presented and/or when it is presented. In particular, in some embodiments, presentation component 220 applies content logic to device features, associated logical hubs, inferred logical locations, or sensed user data to determine aspects of content presentation. For instance, clarification and/or feedback request can be presented to a user via presentation component 220.

In some embodiments, presentation component 220 generates user interface features associated with meetings. Such features can include interface elements (such as graphics buttons, sliders, menus, audio prompts, alerts, alarms, vibrations, pop-up windows, notification-bar or status-bar items, in-app notifications, or other similar features for interfacing with a user), queries, and prompts. In some embodiments, a personal assistant service or application operating in conjunction with presentation component 220 determines when and how to present the meeting content.

Example system 200 also includes storage 225. Storage 225 generally stores information including data, computer instructions (for example, software program instructions, routines, or services), data structures, and/or models used in embodiments of the technologies described herein. By way of example and not limitation, data included in storage 225, as well as any user data, which may be stored in a user profile 240 or meeting profile 270, may generally be referred to throughout as data. Any such data may be sensed or determined from a sensor (referred to herein as sensor data), such as location information of mobile device(s), smartphone data (such as phone state, charging data, date/time, or other information derived from a smartphone), user-activity information (for example: app usage; online activity; searches; voice data such as automatic speech recognition; activity logs; communications data including calls, texts, instant messages, and emails; website posts; other records associated with events; or other activity related information) including user activity that occurs over more than one user device, user history, session logs, application data, contacts data, record data, notification data, social-network data, news (including popular or trending items on search engines or social networks), home-sensor data, appliance data, global positioning system (GPS) data, vehicle signal data, traffic data, weather data (including forecasts), wearable device data, other user device data (which may include device settings, profiles, network connections such as Wi-Fi network data, or configuration data, data regarding the model number, firmware, or equipment, device pairings, such as where a user has a mobile phone paired with a Bluetooth headset, for example), gyroscope data, accelerometer data, other sensor data that may be sensed or otherwise detected by a sensor (or other detector) component including data derived from a sensor component associated with the user (including location, motion, orientation, position, user-access, user-activity, network-access, user-device-charging, or other data that is capable of being provided by a sensor component), data derived based on other data (for example, location data that can be derived from Wi-Fi, Cellular network, or IP address data), and nearly any other source of data that may be sensed or determined as described herein. In some respects, date or information (for example, the requested content) may be provided in user signals. A user signal can be a feed of various data from a corresponding data source. For example, a user signal could be from a smartphone, a home-sensor device, a GPS device (for example, for location coordinates), a vehicle-sensor device, a wearable device, a user device, a gyroscope sensor, an accelerometer sensor, a calendar service, an email account, a credit card account, or other data sources. Some embodiments of storage 225 may have stored thereon computer logic (not shown) comprising the rules, conditions, associations, classification models, and other criteria to execute the functionality of any of the components, modules, analyzers, generators, and/or engines of systems 200.

FIG. 3 is a schematic diagram illustrating different a model 300 that may be used to detect a meeting intent in a written or audible input, according to some embodiments. A meeting intent is an intension to schedule a meeting in the future. The meeting may be a follow up to a current meeting. In addition to detecting the intention to meet, meeting parameters, such as participants, proposed meeting time and date, and meeting topic may be extracted by various machine-learning models.

The model 300 may be used by the meeting-intent detector 261 to identify a meeting intent in a meeting transcript, email, text message, meeting minutes, or some other input to the model 300. In aspects, the input is not a meeting invite, a meeting object on a calendar, or some other content that is dedicated to or has a primary purpose related to meeting schedules. These types of content explicitly generate meetings. Accordingly, extracting a meeting intent is not necessary.

The text producing model/layer 311 receives a document 307 and/or the audio data 305. In some embodiments, the document 307 is a raw document or data object, such as an image of a tangible paper or particular file with a particular extension (for example, PNG, JPEG, GIFF). In some embodiments, the document is any suitable data object, such as a meeting transcript. The audio data 305 may be any data that represents sound, where the sound waves from one or more audio signals have been encoded into other forms, such as digital sound or audio. The resulting form can be recorded via any suitable extensions, such as WAV, Audio Interchange File Format (AIFF), MP3, and the like. The audio data may include natural language utterances, as described herein. The audio may be from a video conference, teleconference, or a recording of an in-person meeting.

The text producing model/layer 311 converts or encodes the document 307 into a machine-readable document and/or converts or encodes the audio data into a document (both of which may be referred to herein as the “output document”). In some embodiments, the functionality of the text producing model/layer 311 represents or includes the functionality as described with respect to the natural language detector 257. For example, in some embodiments, the text producing model/layer 311 performs OCR on the document 307 (an image) in order to produce a machine-readable document. Alternatively or additionally, the text producing model/layer 311 performs speech-to-text functionality to convert the audio data 305 into a transcription document and performs NLP, as described with respect to the natural language utterance detector 257.

The meeting intent model/layer 313 receives, as input, the output document produced by the text producing model/layer 311 (for example, a speech-to-text transcript of a meeting), in order to determine an intent of one or more natural language utterances within the output document. In aspects, other input, such as meeting context for the document 307 may be provided as input, in addition to the document. An “intent” as described herein refers to classifying or otherwise predicting a particular natural language utterance as belonging to a specific semantic meaning. For example, a first intent of a natural language utterance may be to schedule a new meeting, whereas a second intent may be to compliment a user on managing the current meeting.

Some embodiments use one or more natural language models to determine intent, such as intent recognition models, BERT, WORD2VEC, and/or the like. Such models may not only be pre-trained to understand basic human language, such as via MLM and NSP, but can be fine-tuned to understand natural language via the meeting context and the user context. For example, as described with respect to user meeting activity information 242, a user may always discuss a scheduling a follow up meeting at a certain time toward the end of a new product meeting, which is a particular user context. Accordingly, the speaker intent model/layer 313 may determine that the intent is to schedule a new meeting given that the meeting is a new product meeting, the user is speaking, and the certain time has arrived.

In some embodiments, the meeting context refers to any data described with respect to the meeting profile 270. In some embodiments, the user context refers to any data described with respect to the user profile 240. In some embodiments, the meeting context and/or the user context additionally or alternatively represents any data collected via the user-data collection component 210 and/or obtained via the meeting monitor 250.

In some embodiments, an intent is explicit. For instance, a user may directly request or ask for a new meeting, as in “lets schedule a new meeting next week to discuss.” However, in alternative embodiments, the intent is implicit. For instance, the user may not directly request a new meeting. For example, an attendee might say, “let's take this offline.” The attendee may not explicitly request a meeting. However, “taking something offline,” may be understood to mean the user is requesting a meeting or, at least, a follow up discussion. The implicit suggestion may be given a meeting intent, but with a lower confidence score. Aspects of the technology may set a confidence score threshold to render a meeting intent vs. no meeting intent verdict.

In aspects, a detected meeting intent may result in generation of a meeting suggestion that is output to the user. For example, after a video conference concludes, attendees associated with an utterance in which a meeting intent is detected may be presented a meeting suggestion that will schedule a meeting mentioned in their utterance. The attendee may be given the option of initiating the meeting in the meeting suggestion, which will cause a meeting request to be sent to all suggested attendees listed on the meeting suggestions. The meeting suggestion may be generated by the meeting suggestion generator 262. In aspects, the attendee may edit the suggested meeting parameters before the meeting request is sent. For example, the attendee could select a new time, topic, location, etc.

FIG. 4 is a schematic diagram illustrating how a neural network 405 makes particular training and deployment predictions given specific inputs, according to some embodiments. In one or more embodiments, a neural network 405 represents or includes the functionality as described with respect to the meeting intent model 313 or meeting invite generator 315 of FIG. 3.

In various embodiments, the neural network 405 is trained using one or more data sets of the training data input(s) 415 in order to make acceptable loss training prediction(s) 407, which will help later at deployment time to make correct inference prediction(s) 409. In some embodiments, the training data input(s) 415 and/or the deployments input(s) 403 represent raw data. As such, before they are fed to the neural network 405, they may be converted, structured, or otherwise changed so that the neural network 405 can process the data. For example, various embodiments normalize the data, scale the data, impute data, perform data munging, perform data wrangling, and/or any other pre-processing technique to prepare the data for processing by the neural network 405.

In one or more embodiments, learning or training can include minimizing a loss function between the target variable (for example, a relevant content item) and the actual predicted variable (for example, a non-relevant content item). Based on the loss determined by a loss function (for example, Mean Squared Error Loss (MSEL), cross-entropy loss, etc.), the loss function learns to reduce the error in prediction over multiple epochs or training sessions so that the neural network 405 learns which features and weights are indicative of the correct inferences, given the inputs. Accordingly, it may be desirable to arrive as close to 100% confidence in a particular classification or inference as possible to reduce the prediction error. In an illustrative example, the neural network 405 can learn over several epochs that for a given transcript document (or natural language utterance within the transcription document) or application item (such as a calendar item), as indicated in the training data input(s) 415, the likely or predicted correct meeting intent or suggested meeting parameters.

Subsequent to a first round/epoch of training (for example, processing the “training data input(s)” 415), the neural network 405 may make predictions, which may or may not be at acceptable loss function levels. For example, the neural network 405 may process a transcript portion of the training input(s) 415. Subsequently, the neural network 405 may predict that no meeting intent is detected. This process may then be repeated over multiple iterations or epochs until the optimal or correct predicted value(s) is learned (for example, by maximizing rewards and minimizing losses) and/or the loss function reduces the error in prediction to acceptable levels of confidence. For example, using the illustration above, the neural network 405 may learn that the transcript portion is associated with or likely will include a meeting intent.

In one or more embodiments, the neural network 405 converts or encodes the runtime input(s) 403 and training data input(s) 415 into corresponding feature vectors in feature space (for example, via a convolutional layer(s)). A “feature vector” (also referred to as a “vector”) as described herein may include one or more real numbers, such as a series of floating values or integers (for example, [0, 1, 0, 0]) that represent one or more other real numbers, a natural language (for example, English) word and/or other character sequence (for example, a symbol (for example, @, !, #), a phrase, and/or sentence, etc.). Such natural language words and/or character sequences correspond to the set of features and are encoded or converted into corresponding feature vectors so that computers can process the corresponding extracted features. For example, for a given detected natural language utterance of a given meeting and for a given suggestion user, embodiments can parse, tokenize, and encode each deployment input 403 value—an ID of suggestion attendee, a natural language utterance (and/or intent of such utterance), the ID of the speaking attendee, an application item associated with the meeting, an ID of the meeting, documents associated with the meeting, emails associated with the meeting, chats associated with the meeting, and/or other metadata (for example, time of file creation, last time a file was modified, last time file was accessed by an attendee), all into a single feature vector.

In some embodiments, the neural network 405 learns, via training, parameters, or weights so that similar features are closer (for example, via Euclidian or Cosine distance) to each other in feature space by minimizing a loss via a loss function (for example, Triplet loss or GE2E loss). Such training occurs based on one or more of the training data input(s) 415, which are fed to the neural network 405. For instance, if several people attend the same meeting or meetings with similar topics (a monthly sales meeting), then each attendee would be close to each other in vector space and indicative of a prediction that the next time the meeting invite is shared, there is a strong likelihood that the corresponding attendees may be invited to a future meeting.

Similarly, in another illustrative example of training, some embodiments learn an embedding of feature vectors based on learning (for example, deep learning) to detect similar features between training data input(s) 415 in feature space using distance measures, such as cosine (or Euclidian) distance. For example, the training data input 415 is converted from string or other form into a vector (for example, a set of real numbers) where each value or set of values represents the individual features (for example, historical documents, emails, or chats) in feature space. Feature space (or vector space) may include a collection of feature vectors that are each oriented or embedded in space based on an aggregate similarity of features of the feature vector. Over various training stages or epochs, certain feature characteristics for each target prediction can be learned or weighted.

In one or more embodiments, the neural network 405 learns features from the training data input(s) 415 and responsively applies weights to them during training. A “weight” in the context of machine learning may represent the importance or significance of a feature or feature value for prediction. For example, each feature may be associated with an integer or other real number where the higher the real number, the more significant the feature is for its prediction. In one or more embodiments, a weight in a neural network or other machine learning application can represent the strength of a connection between nodes or neurons from one layer (an input) to the next layer (an output). A weight of 0 may mean that the input will not change the output, whereas a weight higher than 0 changes the output. The higher the value of the input or the closer the value is to 1, the more the output will change or increase. Likewise, there can be negative weights. Negative weights may proportionately reduce the value of the output. For instance, the more the value of the input increases, the more the value of the output decreases. Negative weights may contribute to negative scores.

The training data may be labeled with a ground truth designation. For example, some embodiments assign a positive label to transcript portions, emails and/or files that include a meeting intent and a negative label to all emails, transcript portions, and files that do not have a meeting intent.

In one or more embodiments, subsequent to the neural network 405 training, the machine learning model(s) 405 (for example, in a deployed state) receives one or more of the deployment input(s) 403. When a machine-learning model is deployed, it has typically been trained, tested, and packaged so that it can process data it has never processed. Responsively, in one or more embodiments, the deployment input(s) 403 are automatically converted to one or more feature vectors and mapped in the same feature space as vector(s) representing the training data input(s) 415 and/or training predictions). Responsively, one or more embodiments determine a distance (for example, a Euclidian distance) between the one or more feature vectors and other vectors representing the training data input(s) 415 or predictions, which is used to generate one or more of the inference prediction(s) 409.

In certain embodiments, the inference prediction(s) 409 may either be hard (for example, membership of a class is a binary “yes” or “no”) or soft (for example, there is a probability or likelihood attached to the labels). Alternatively or additionally, transfer learning may occur. Transfer learning is the concept of re-utilizing a pre-trained model for a new related problem (for example, a new video encoder, new feedback, etc.).

FIG. 5 is a schematic diagram of an example meeting-oriented knowledge graph 268, according to some embodiments. In some embodiments, the knowledge graph 268 represents meeting relationships with each other, attendees, and meeting content (e.g., transcript). A knowledge graph is a visualization for a set of objects where pairs of objects are connected by links or “edges.” The interconnected objects are represented by points termed “vertices,” or “nodes” and the links that connect the nodes are called “edges.” Each node or vertex represents a particular position in a one-dimensional, two-dimensional, three-dimensional (or any other dimensions) space. A vertex is a point where one or more edges meet. An edge connects two vertices. Specifically, the knowledge graph 268 (an undirected graph) includes the nodes or vertices of: meeting A 501, meeting B 511, meeting C 521, participant 1 502, participant 2 503, participant 3 504, participant 4 505, participant 5 506, participant 6 512, transcript A 507, transcript B 517, and transcript C 527. The network graph further includes the edges 540, 541, 542, 543, 544, 545, 546, 547, 548, 549, 550, 551, and 552. Edges indicate a relationship between connected notes. For example, edges between a meeting and a participant indicate that the participant was an attendee at the meeting. Edges between meetings indicate the meetings are related. Edges between a meeting and a transcript indicate that a meeting and transcript are related. For example, the edge between meeting A 501 and transcript A 507 indicate that transcript A 501 is related to meeting A 507.

As described previously, aspects the technology described herein may analyze the transcript and detect one or more meeting intents within. When the meeting intent for a new meeting is detected in the utterance (or other meeting content) from a first meeting, then the technology described herein may relate the first meeting to the new meeting. The relationship can be recorded as an edge between nodes in a knowledge graph that stores meetings as nodes. FIG. 5 shows that intent B 508 was identified in transcript A 507 and intent C 519 was detected in transcript B 517. Intent B 508 may have been identified in utterance 510 made by participant 5 506. Intent C 518 may have been identified in utterance 520 made by participant 1 502.

Intent B 508 was to schedule meeting B 511. The detection of intent B within transcript A 507 is used to relate meeting A 501 to meeting B 511. This relationship may be built on a rule that relates meetings when an intention for a second meeting is detected in a first meeting. Upon detecting an intent for a meeting, the technology described herein may present a meeting suggestion to one or more attendees of the meeting, including the attendee who made the utterance from which the meeting intention was identified.

FIG. 5 shows a schedule meeting B suggestion 509 and a schedule meeting C suggestion 519. It should be noted that neither the suggestions (509, 519) nor intents (508, 518) are part of the knowledge graph 268. Rather, these are actions or conclusions enabled by the information in the knowledge graph 268. However, a record of identified intents or meeting suggestions made could be stored with a meeting profile 270.

The knowledge graph 268 specifically shows the relationships between multiple users, a meeting, and content items, such transcripts. It is understood that these items are representative only. Representing computer resources as vertices allow users, meeting, and content items to be linked in a manner they may not have otherwise have been. For example, meetings may be related to each other.

In some embodiments, the knowledge graph 268 is used as input into a machine-learning model (such as the neural network 315) so that the model can learn relationships between meeting parameters, meetings, and attendees even when there is no explicit link. This knowledge may help the model pick favorable times and places to schedule a meeting.

The edges may have characteristics. For example, the edge may be associated with a person who made the utterance in which a meeting intent was detected. The edge could be associated with other entities extracted from the utterance. The edge could indicate a strength of relationship. The strength of relationship could be related to a confidence factor associated with the meeting intent prediction. The strength of relationship could indicate how many different utterances contained meeting intents. For example, if three utterances in a first meeting indicated a meeting intent for a second scheduled meeting then the edge between meetings could indicate the relationship is based on three utterances.

Turning now to FIG. 6, an example screenshot 600 illustrating presentation of a meeting suggestion 604, according to some embodiments. In some embodiments, the presentation of the meeting suggestion 604 represents an output of the system 200 of FIG. 2, the meeting suggestion model/layer 315 of FIG. 3, and/or the inference prediction(s) 409 of FIG. 4. For example, the meeting suggestion 604 represents that a meeting invite has been detected from an utterance and a meeting suggestion generated in response. In some embodiments, the screenshot 600 specifically represents what is caused to be displayed by the presentation component 220 of FIG. 2. In some embodiments, the screenshot 600 represents a page or other instance of a consumer application (such as MICROSOFT TEAMS) where users can collaborate and communicate with each other (for example, via instant chat, video conferencing, and/or the like).

Continuing with FIG. 6, at a first time the meeting attendee 620 utters the natural language utterance 602—“Sven, can we discuss the figures next week . . . ” In some embodiments, in response to such natural language utterance 602, the natural language utterance detector 257 detects the natural language utterance 620. In some embodiments, in response to the detection of the natural language utterance, various functionality may automatically occur as described herein, such as the functionality as described with respect to one or more components of the meeting manager 260, the text producing model/layer 311, the speaker intent model/layer 313, the meeting suggestion model/layer 315, the neural network 405, and/or a walk of the knowledge graph 268 in order to generate a meeting suggestion. In response to generating a meeting suggestion, the presentation component 220 automatically causes presentation, during the meeting or after the meeting, of the suggestion 604. The suggestion may include a meeting topic 606, meeting time 612, and an option to generate a meeting invite by selecting yes 607 or no 608. The meeting topic may be extracted from natural language utterance in which the meeting intent was detected. The meeting context data and user data may also be used to identify meeting parameters or details. The suggested time may be based on the utterance “next week” with the time determined by analyzing the invites availability on electronic calendars.

The suggestion 604 may be presented to the user who made the utterance in which the meeting invite intention was detected. In other aspects, the suggestion 604 is visible to all attendees. In another aspect, the suggestion 604 is visible to all attendees associated with the suggestion. An attendee may be associated with the meeting suggestion 604 when they are invited to the proposed meeting. When multiple meeting intentions are detected in utterances made during a meeting, the suggestion 604 may include multiple meetings each with its own time, suggested attendees and associated parameters (e.g., location). Each of these meetings may be related to the first meeting and to each other within the meeting-oriented knowledge graph. The mention of one or more meetings (or an intent to schedule one or more meetings) in a first meeting may be used as a criteria to relate the other meetings to the first meeting and to each other. The mention of a meeting that occurred previously, can be a criteria used to link the current meeting to a past meeting, if the two meetings were not linked previously.

FIG. 7 is an example screenshot 700 illustrating presentation of a meeting tree 720, according to some embodiments. The purpose of the meeting tree 720 is to help visually depict a meeting's purpose and relationship to other meetings. The meeting tree 720 can help a user determine whether to attend and/or prepare for meeting. The visual depiction of other meetings related to a particular meeting can help the attendee or potential attendee understand the present meeting's purpose. The meeting tree 720 can also be a helpful visualization when analyzing the effectiveness of meetings. For example, if a dozen related meetings have occurred without making a meaningful decision, then a meeting organizer may use the meeting tree to quickly access meeting information to help understand and improve meeting effectiveness. The meeting organizer may choose to invite different people or make other changes to help drive decision processes forward.

A meeting tree 720 is an example of an analytic that can be derived from the meeting-oriented knowledge graph 268. The meeting tree 720 shows various meetings and their relation to each other. The meeting tree 720 includes meeting A 701, meeting B 702, meeting C 703, meeting D 704, meeting E 705, meeting F 706, meeting H 707, and meeting I 708. The lines between meetings indicate a direct relationship between meetings. The arrows may indicate a chronological order of meetings with an arrow pointing to subsequent meetings. The arrows may also point to the detection of a meeting intent in a first meeting with an arrow pointing to a meeting that resulted from a detected meeting intent. All meetings in a meeting tree 720 may be related to one another either directly or indirectly. Meetings are directly related when an intent for the second meeting is detected in the first meeting. Meetings are indirectly related when directly or indirectly related to a common meeting. In this meeting tree 720, all of the meetings are directly or indirectly related to meeting A 701, and, therefore related to each other.

In some instances, a meeting intent for a second meeting could be detected in two different meetings. For example, in meeting B 702 an attendee could say, “we need to talk about the memory usage issue off-line.” A meeting intent could be detected in this utterance and a meeting suggestion presented to the attendee. The attendee could use the meeting suggestion to schedule a meeting F 706. This would cause meeting B 702 to be related to meeting F 706 in a meeting-centric knowledge graph. Subsequent to meeting F 706 being scheduled, an attendee could ask to add an agenda item to, “our meeting tomorrow.”

A meeting intent could also be detected in this utterance. However, because the utterance mentioned a scheduled meeting, a suggestion to schedule a new meeting may not be provided. Instead, the meeting suggestion could be presented to ask whether the meeting referenced in the utterance was meeting F 706. Upon receiving confirmation, meeting F 706 and meeting E 705 could be designated as related. A confirmation is not required to form a relationship between meetings. In aspects, the relationship is identified and stored in a meeting-centric knowledge graph 268 without the confirmation.

The meeting tree 720 may enable viewers to access meeting details by selecting one of the meeting visualizations. In this example, meeting details 709 are shown for meeting I 708. The meeting details include a meeting thread ID, meeting date, attendee list, link to a meeting transcript, link to meeting content, and a notation of decisions taken in the meeting. The meeting thread ID includes a thread designation 710 and an individual meeting ID 711. Every meeting in the meeting tree 720 may be associated with the same thread designation 710 but be assigned a unique meeting ID 711. The unique meeting ID 711 may be assigned sequentially. As mentioned, the transcript can be generated for meetings associated with an audio recording of utterances during the meeting. The transcript may be saved in association with the meeting ID, thread ID, or through other identification. In a similar way meeting content, such as a presentation given during a meeting, meeting notes, meeting minutes, meeting chat, and other content related to the meeting may be accessible through a link to the content.

The decisions taken during a meeting may be derived from an analysis of the meeting transcript. A decision intent may be detected through a machine-learning model similar to that described previously with reference to FIGS. 3 and 4. However, the training data could provide positive and negative examples of decisions described in a meeting transcript. Snippets of the transcript may be used to describe the decision.

In aspects, the meeting tree 720 may visually arrange meetings to depict meeting characteristics relative to other meetings. For example, the meeting date may be depicted by putting earlier meetings towards the top of the display and subsequent meetings towards the bottom. Meetings occurring on the same horizontal arrangement may communicate that the meetings occurred contemporaneously with one another, such as during the same week or day. As an alternative, meetings located next to each other within the meeting tree could indicate similar attendees. In an aspect, meetings attended by a viewer of the meeting tree may be visually differentiated to indicate that the viewer attended those meetings. For example, meeting A 701, meeting E 705, and meeting F 706 may be presented in a different color than other meetings, bolded, or otherwise highlighted to indicate the viewer attended these meetings. A notice may communicate that the viewer attended the visually differentiated meeting.

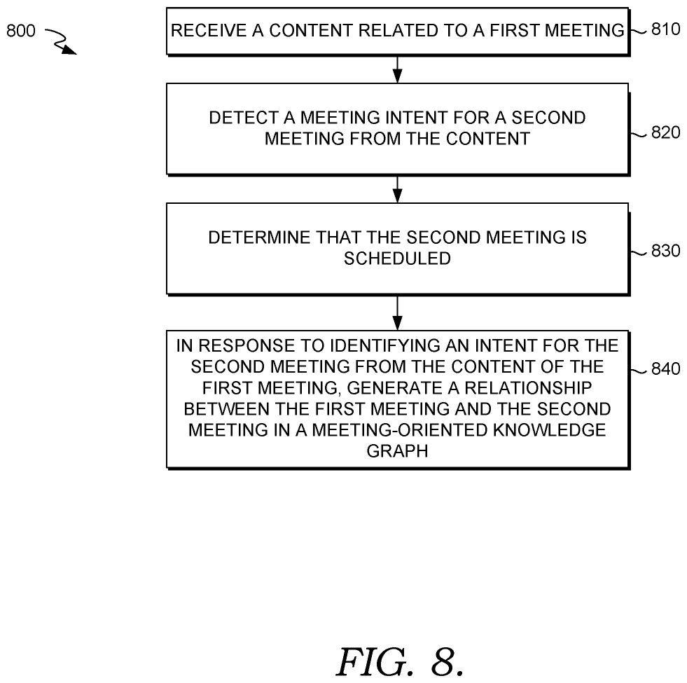

Now referring to FIGS. 8-10, each block of methods 800, 900, and 1000, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The method may be provided by a standalone application, a service or hosted service (standalone or in combination with another hosted service), to name a few. In addition, methods 800, 900, and 1000 are described, by way of example, with respect to the meeting manager 260 of FIG. 2 and additional features of FIGS. 3-7. However, these methods may additionally or alternatively be executed by any one system, or any combination of systems, including, but not limited to, those described herein.

FIG. 8 describes a method 800 of managing relationships between meetings, according to an aspect of the technology described herein. At step 810, the method 800 includes receiving a content related to a first meeting. The content may be a transcript of the first meeting. The transcript may be generated by transcribing audio of the meeting. The audio may be recorded and transcribed by virtual meeting platforms, such a video conferencing software. In another aspect, the content may be an email, meeting invite, meeting record, document, or other content associated with an email. Content may be associated with a meeting if presented during a meeting, referenced in a meeting invite, referenced or attached to an email or other communication that identifies a meeting, such as a reply from a meeting invite or meeting record. Other methods of associating content with a meeting are possible.

At step 820, the method 800 includes detecting a meeting intent for a second meeting from the content. Identifying a meeting intent has been described previous. The intent may be detected using a machine-learning model, such as previously described with reference to FIGS. 3 and 4.

At step 830, the method 800 includes determining that the second meeting is scheduled. Determining that the second meeting is scheduled may occur when a user affirmatively responds to a meeting suggestion provided in response to detecting the meeting intent. Meetings suggestions have been described herein. In another aspect, a meeting is determined to be scheduled when a meeting with meeting parameters having a threshold similarity to a suggested meeting is detected on a proposed attendee's calendar.

At step 840, the method 800 includes, in response to identifying an intent for the second meeting in the content from the first meeting, generating a relationship between the first meeting and the second meeting in a meeting-oriented knowledge graph. A meeting-oriented knowledge graph has been described with reference to FIG. 6. In an aspect, the first meeting is a graph node and the second meeting is a graph node. An edge may indicate the relationship. In an aspect, an edge can indicate a strength of relationship. For example, if an intent for a second meeting is detected in multiple utterances by multiple attendees in a first meeting then a stronger relationship between the first and second meeting may be indicated than if only a single utterance in a first meeting has a meeting intent.

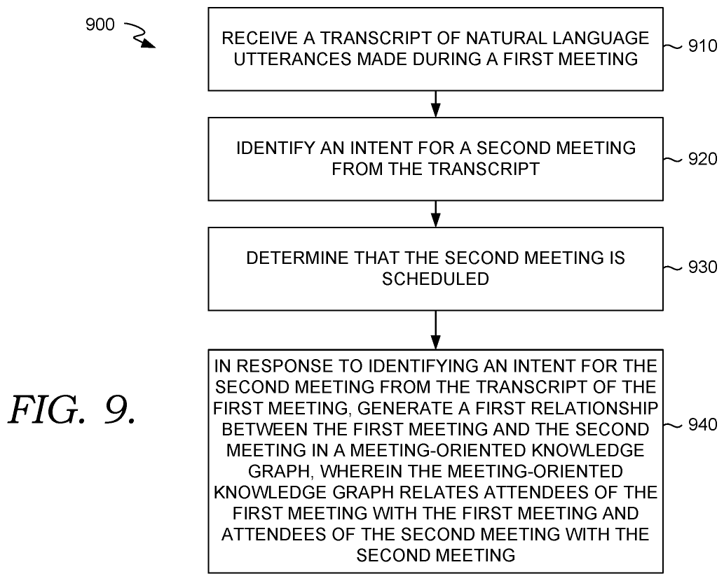

FIG. 9 describes a method 900 of managing relationships between meetings, according to an aspect of the technology described herein. At step 910, the method 900 includes receiving a transcript of natural language utterances made during a first meeting. The transcript may be generated by transcribing audio of the meeting. The audio may be recorded and transcribed by virtual meeting platforms, such a video conferencing software.

At step 920, the method 900 includes identifying an intent for a second meeting from the transcript. The transcript may include a textual rendering of the utterance produced through speech to text translation. Identifying a meeting intent has been described previous. The intent may be detected using a machine-learning model, such as previously described with reference to FIGS. 3 and 4.

At step 930, the method 900 includes determining that the second meeting is scheduled. Determining that the second meeting is scheduled may occur when a user affirmatively responds to a meeting suggestion provided in response to detecting the meeting intent. Meetings suggestions have been described herein. In another aspect, a meeting is determined to be scheduled when a meeting with meeting parameters having a threshold similarity to a suggested meeting is detected on a proposed attendee's calendar.

At step 940, the method 900 includes, in response to identifying an intent for the second meeting from the transcript of the first meeting, generating a first relationship between the first meeting and the second meeting in a meeting-oriented knowledge graph, wherein the meeting-oriented knowledge graph relates attendees of the first meeting with the first meeting and attendees of the second meeting with the second meeting. A meeting-oriented knowledge graph has been described with reference to FIG. 6. In an aspect, the first meeting is a graph node and the second meeting is a graph node. An edge may indicate the relationship. In an aspect, an edge can indicate a strength of relationship. For example, if an intent for a second meeting is detected in multiple utterances by multiple attendees in a first meeting then a stronger relationship between the first and second meeting may be indicated than if only a single utterance in a first meeting has a meeting intent.

FIG. 10 describes a method 1000 of managing relationships between meetings, according to an aspect of the technology described herein. At step 1010, the method 1000 includes receiving a natural language utterance made by a first attendee during a virtual meeting. The natural language utterance may be spoken by a meeting attendee. The natural language utterance may be received in a transcript of the meeting.

At step 1020, the method 1000 includes identifying an intent for a second meeting with a second person from the first natural language utterance. Identifying a meeting intent has been described previous. The intent may be detected using a machine-learning model, such as previously described with reference to FIGS. 3 and 4.

At step 1030, the method 1000 includes identifying one or more parameters for the second meeting from content associated with the virtual meeting. The parameters may be described, at least in part, by performing entity extraction on the utterance and additional utterances made during the meeting. The entities extracted can include suggested attendees, times, locations, and topics of discussion.

At step 1040, the method 1000 includes in response to the intent, causing presentation of a meeting suggestion to the first attendee, the meeting suggestion including the first attendee and the second person as participants with a meeting characteristic based on the one or more parameters. The meeting characteristics can include a topic, attendees, date, time, location, virtual meeting platform, and the like.

At step 1050, the method 1000 includes receiving an affirmation of the meeting suggestion. The affirmation may be provided by selecting a user interface command, such as the yes input in FIG. 5. A user may adopt the suggested parameters and cause a meeting invite to be sent to suggested participants. The user may also edit the suggested parameters before the meeting invite is sent.

At step 1060, the method 1000 includes generating a first relationship between the virtual meeting and the second meeting in a meeting-oriented knowledge graph, wherein the meeting-oriented knowledge graph includes a second relationship between a transcript of the virtual meeting and the virtual meeting. A meeting-oriented knowledge graph has been described with reference to FIG. 6. In an aspect, the first meeting is a graph node and the second meeting is a graph node. An edge may indicate the relationship. In an aspect, an edge can indicate a strength of relationship. For example, if an intent for a second meeting is detected in multiple utterances by multiple attendees in a first meeting then a stronger relationship between the first and second meeting may be indicated than if only a single utterance in a first meeting has a meeting intent.

### Overview of Example Operating Environment

Having described various embodiments of the disclosure, an exemplary computing environment suitable for implementing embodiments of the disclosure is now described. With reference to FIG. 11, an exemplary computing device 1100 is provided and referred to generally as computing device 1100. The computing device 1100 is but one example of a suitable computing environment and is not intended to suggest any limitation as to the scope of use or functionality of the disclosure. Neither should the computing device 1100 be interpreted as having any dependency or requirement relating to any one or combination of components illustrated.

Embodiments of the disclosure may be described in the general context of computer code or machine-useable instructions, including computer-useable or computer-executable instructions, such as program modules, being executed by a computer or other machine, such as a smartphone, a tablet PC, or other mobile device, server, or client device. Generally, program modules, including routines, programs, objects, components, data structures, and the like, refer to code that performs particular tasks or implements particular abstract data types. Embodiments of the disclosure may be practiced in a variety of system configurations, including mobile devices, consumer electronics, general-purpose computers, more specialty computing devices, or the like. Embodiments of the disclosure may also be practiced in distributed computing environments where tasks are performed by remote-processing devices that are linked through a communications network. In a distributed computing environment, program modules may be located in both local and remote computer storage media including memory storage devices.

Some embodiments may comprise an end-to-end software-based system that can operate within system components described herein to operate computer hardware to provide system functionality. At a low level, hardware processors may execute instructions selected from a machine language (also referred to as machine code or native) instruction set for a given processor. The processor recognizes the native instructions and performs corresponding low-level functions relating, for example, to logic, control and memory operations. Low-level software written in machine code can provide more complex functionality to higher levels of software. Accordingly, in some embodiments, computer-executable instructions may include any software, including low-level software written in machine code, higher-level software such as application software and any combination thereof. In this regard, the system components can manage resources and provide services for system functionality. Any other variations and combinations thereof are contemplated with embodiments of the present disclosure.

With reference to FIG. 11, computing device 1100 includes a bus 10 that directly or indirectly couples the following devices: memory 12, one or more processors 14, one or more presentation components 16, one or more input/output (I/O) ports 18, one or more I/O components 20, and an illustrative power supply 22. Bus 10 represents what may be one or more busses (such as an address bus, data bus, or combination thereof). Although the various blocks of FIG. 11 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 11 is merely illustrative of an exemplary computing device that can be used in connection with one or more embodiments of the present disclosure. Distinction is not made between such categories as “workstation,” “server,” “laptop,” “handheld device,” or other computing device, as all are contemplated within the scope of FIG. 11 and with reference to “computing device.”

Computing device 1100 typically includes a variety of computer-readable media. Computer-readable media can be any available media that can be accessed by computing device 1100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 1100. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 12 includes computer storage media in the form of volatile and/or nonvolatile memory. The memory may be removable, non-removable, or a combination thereof. Exemplary hardware devices include solid-state memory, hard drives, optical-disc drives, or other hardware. Computing device 1100 includes one or more processors 14 that read data from various entities such as memory 12 or I/O components 20. Presentation component(s) 16 presents data indications to a user or other device. Exemplary presentation components include a display device, speaker, printing component, vibrating component, and the like.

The I/O ports 18 allow computing device 1100 to be logically coupled to other devices, including I/O components 20, some of which may be built in. Illustrative components include a microphone, joystick, game pad, satellite dish, scanner, printer, wireless device, and the like. The I/O components 20 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 1100. The computing device 1100 may be equipped with depth cameras, such as stereoscopic camera systems, infrared camera systems, RGB camera systems, and combinations of these, for gesture detection and recognition. Additionally, the computing device 1100 may be equipped with accelerometers or gyroscopes that enable detection of motion. The output of the accelerometers or gyroscopes may be provided to the display of the computing device 1100 to render immersive augmented reality or virtual reality.

Some embodiments of computing device 1100 may include one or more radio(s) 24 (or similar wireless communication components). The radio 24 transmits and receives radio or wireless communications. The computing device 1100 may be a wireless terminal adapted to receive communications and media over various wireless networks. Computing device 1100 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include, by way of example and not limitation, a Wi-Fi® connection to a device (for example, mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Having identified various components utilized herein, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (for example, machines, interfaces, functions, orders, and groupings of functions, and the like.) can be used in addition to or instead of those shown.

Embodiments of the present disclosure have been described with the intent to be illustrative rather than restrictive. Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

The term “set” may be employed to refer to an ordered (i.e., sequential) or an unordered (i.e., non-sequential) collection of objects (or elements), such as but not limited to data elements (for example, events, clusters of events, and the like). A set may include N elements, where N is any non-negative integer. That is, a set may include 0, 1, 2, 3, . . . N objects and/or elements, where N is an positive integer with no upper bound. Therefore, a set may be a null set (i.e., an empty set), that includes no elements. A set may include only a single element. In other embodiments, a set may include a number of elements that is significantly greater than one, two, or three elements. The term “subset,” is a set that is included in another set. A subset may be, but is not required to be, a proper or strict subset of the other set that the subset is included in. That is, if set B is a subset of set A, then in some embodiments, set B is a proper or strict subset of set A. In other embodiments, set B is a subset of set A, but not a proper or a strict subset of set A.

The invention claimed is:

1. A system comprising:
at least one computer processor; and
one or more computer storage media storing computer-useable instructions that, when used by the at least one computer processor, cause the at least one computer processor to perform operations comprising:
receiving a content related to a first meeting;
detecting a meeting intent for a second meeting from the content;
determining that the second meeting is scheduled; and
in response to detecting the meeting intent for the second meeting from the content of the first meeting, generating a relationship between the first meeting and the second meeting in a meeting-oriented knowledge graph.

2. The system of claim 1, wherein the content is a first natural language utterance by one or more attendees of the first meeting during the first meeting.

3. The system of claim 2, wherein the operations further comprise transcribing the first natural language utterance from the first meeting to a textual transcript and performing natural language processing of the textual transcript to detect the meeting intent.

4. The system of claim 1, wherein the operations further comprise associating the first meeting and the second meeting with a single meeting thread identification.

5. The system of claim 1,
wherein the method further comprises identifying an intent for a third meeting from the content related to the first meeting;
generating a third relationship between the third meeting and the first meeting in the meeting-oriented knowledge graph; and
generating a fourth relationship between the second meeting and third meeting in the meeting-oriented knowledge graph

6. The system of claim 5, wherein the first meeting, the second meeting, and each attendee of the attendees of the first meeting are nodes in the meeting-oriented knowledge graph, and wherein relationships between the nodes are indicated by edges.

7. The system of claim 1, wherein the meeting-oriented knowledge graph relates a decision taken in the first meeting to the first meeting in the meeting-oriented knowledge graph.

8. The system of claim 1, wherein the operations further comprise generating a meeting analytic by traversing the meeting-oriented knowledge graph and outputting the meeting analytic through a graphical user interface.

9. A computer-implemented method comprising:
receiving a transcript of natural language utterances made during a first meeting;
identifying an intent for a second meeting from the transcript;
determining that the second meeting is scheduled; and
in response to identifying an intent for the second meeting from the transcript of the first meeting, generating a first relationship between the first meeting and the second meeting in a meeting-oriented knowledge graph, wherein the meeting-oriented knowledge graph relates attendees of the first meeting with the first meeting and attendees of the second meeting with the second meeting.

10. The computer-implemented method of claim 9, further comprising generating a second relationship between the transcript and the first meeting in the meeting-oriented knowledge graph.

11. The computer-implemented method of claim 9, wherein the method further comprises assigning a common meeting thread identification to the first meeting and the second meeting.

12. The computer-implemented method of claim 9, wherein the method further comprises identifying an intent for a third meeting from the transcript;
generating a third relationship between the third meeting and the first meeting in the meeting-oriented knowledge graph; and
generating a fourth relationship between the second meeting and third meeting in the meeting-oriented knowledge graph.

13. The computer-implemented method of claim 9, wherein the method further comprises generating a meeting analytic from the meeting-oriented knowledge graph and outputting the meeting analytic through a graphical user interface.

14. The computer-implemented method of claim 13, wherein the meeting analytic is a number of related meetings occurring before attendees in the related meetings made a decision.

15. The computer-implemented method of claim 9, wherein the method further comprises generating, from the meeting-oriented knowledge graph, a meeting tree that visually illustrates a relationship between the first meeting and the second meeting; and causing the meeting tree to be output for display.

16. One or more computer storage media having computer-executable instructions embodied thereon that, when executed by one or more processors, cause the one or more processors to perform operations comprising:
receiving a first natural language utterance made by a first attendee during a virtual meeting;
identifying an intent for a second meeting with a second person from the first natural language utterance;
identifying one or more parameters for the second meeting from content associated with the virtual meeting;
in response to identifying the intent, causing presentation of a meeting suggestion to the first attendee, the meeting suggestion including the first attendee and the second person as participants with a meeting characteristic based on the one or more parameters;
receiving an affirmation of the meeting suggestion; and
generating a first relationship between the virtual meeting and the second meeting in a meeting-oriented knowledge graph, wherein the meeting-oriented knowledge graph includes a second relationship between a transcript of the virtual meeting and the virtual meeting.

17. The one or more computer storage media of claim 16, the method further comprising identifying an intent for a third meeting from a second natural language utterance made during the virtual meeting;
generating a third relationship between the third meeting and the first meeting in the meeting-oriented knowledge graph; and
generating a fourth relationship between the second meeting and third meeting in the meeting-oriented knowledge graph

18. The one or more computer storage media of claim 17, wherein the method further comprises generating a meeting analytic from the meeting-oriented knowledge graph and outputting the meeting analytic through a graphical user interface, wherein the meeting analytic is an amount of decisions made per meeting in a group of related meetings.

19. The one or more computer storage media of claim 16, wherein the method further comprises generating, from the meeting-oriented knowledge graph, a meeting tree that visually illustrates a relationship between the virtual meeting and the second meeting; and causing the meeting tree to be output for display.

20. The one or more computer storage media of claim 16, wherein the method further comprises assigning a common meeting thread identification to the virtual meeting and the second meeting.
